(19) United States
(12) Patent Application Publication
(10) Pub. No.: US 2018/0126552 A1
(43) Pub. Date: May 10, 2018

(54) Method And Controller System For Controlling Backlash

(71) Applicant: ABB Schweiz AG, Baden (CH)

(72) Inventors: Ingvar JONSSON, Västerås (SE); Tomas GROTH, Västerås (SE)

(21) Appl. No.: 15/569,040

(22) PCT Filed: Jun. 10, 2015
(86) PCT No.: PCT/EP2015/062870

§ 371 Date: Oct. 24, 2017

(51) Int. Cl. B25J 9/16; G05B 19/404

(52) U.S. Cl. CPC B25J 9/1641; G05B 19/404; Y10S 901/09; G05B 2219/41034; B25J 9/1692

(57) ABSTRACT

A method of controlling backlash of a first driven gear and a second driven gear mechanically connected in parallel with an actuator gear, and which first, second, and third gears form a gear train. The method includes a) obtaining a current position of the gear train, b) obtaining a current backlash value of the gear train from a data structure having a plurality of pairs of positions of the gear train and corresponding backlash value which have all been determined in an empirical manner for the actuator gear, c) determining a first backlash compensation for the first gear motor and a second backlash compensation for the second gear motor, wherein the first and second backlash compensations are equal and opposite values based on the current backlash value, and d) controlling the first and second gear motors based on the compensations.

### TECHNICAL FIELD

The present disclosure generally relates to backlash control. In particular it relates to a method and to a controller system for controlling backlash by means of two or more motors.

### BACKGROUND

Backlash is a gap or play between the engaging gear flanks of two gears. The backlash is thus a clearance caused by the gap between the gear flanks. To this end, a gear may be moved a distance corresponding to the backlash relative to another gear without mechanical engagement. Backlash is undesirable because it impairs control of the object that is actuated by an actuator gear. Control impairment results from bad path performance when a cog is moving from one gear flank to the other gear flank of that cog, or from imprecise positioning when a cog's location is uncertain in the gap between two cogs.

An actuator gear is arranged to actuate an object such as an industrial robot, and is driven by one or more gears that in turn are driven by one or more motors. The backlash occurs between the actuator gear and the gear(s) that drive(s) the actuator gear. Especially for large manipulator arms, the mechanical precision in gears may relatively low. This results in large backlash. One solution to avoid backlash in these situations is to use high-precision gears. High-precision gears are however extremely expensive and difficult to purchase.

The paper “Precise robot motions using dual motor control” by Robertz et al., 2010 IEEE International Conference on Robotics and Automation, Anchorage Convention District, May 3-8, 2010, Anchorage, Ak., USA, discloses a method for reducing backlash in industrial robot control. This paper discloses an approach based on dual motors connected in parallel to the load. Different control strategies are presented and evaluated in experiments ranging from a lab servo process via a table-sized robot to a large industrial implementation with several meters of working range. Special emphasis is on a dual motor test rig with a linear high-resolution scale where the combined motor torque was fully utilized for high acceleration, while reducing backlash by over 96%. The paper discloses a position reference offset method where the first motor always is a master and the second motor always is the slave, meaning that the slave motor has to adapt its operation to the master motor.

A drawback with the solution disclosed in the paper by Robertz et al. is that this paper does not take into account that in reality the actuator gear, or any of the gears included in the gear train, may have an eccentricity and/or slight differences between the cogs because of manufacturing defects. These defects result in potentially unique backlash between each pair of cogs of a gear. In the disclosure of Robertz et al. it is assumed that the gears are ideal. Moreover in a stationary positioning, the master always takes the entire load as well as the spanning provided by the slave motor to reduce backlash, i.e. opposite directional torque, and therefore requires unnecessarily large dimensioning of the master motor.

### SUMMARY

In view of the above, an object of the present disclosure is to solve, or at least mitigate, the problems of the prior art.

Hence, according to a first aspect of the present disclosure there is provided a method of controlling backlash by means of a first motor driving a first gear and a second motor driving a second gear, which first gear and second gear are mechanically connected in parallel with an actuator gear, and which first gear, second gear and third gear form a gear train. The method comprises: a) obtaining a current position of the gear train relative to a reference position of the gear train, b) obtaining a current backlash value for the current position from a data structure comprising a plurality of pairs of positions of the gear train and corresponding backlash values which have all been determined in an empirical manner for the actuator gear, the first gear and the second gear under control, which positions contained in the data structure are distributed along the entire work range of the actuator gear, and wherein the current backlash value is obtained by finding a position of the gear train in the data structure corresponding to the current position and thereby identifying the corresponding backlash value, c) determining a first backlash compensation for the first motor and a second backlash compensation for the second motor, wherein the first backlash compensation is based on a first component that includes the current backlash value with the sign of the first component being a function of a motor torque of the first motor and the second backlash compensation is based on a third component that includes the current backlash value with the sign of the third component being a function of a motor torque of the second motor, and d) controlling the first motor based on the first backlash compensation and controlling the second motor based on the second backlash compensation.

By means of determining the current backlash value from a plurality of empirically determined backlashes for a plurality of positions of the actuator gear, first gear and second gear, it can be ensured that an exact current backlash value for the current position of the actuator gear can be determined. Since a more precise current backlash value can be determined, backlash control is consequently more precise.

Furthermore, by providing backlash compensation with the same value, i.e. the same magnitude, but with opposite signs, as is the case with the first backlash compensation and the second backlash compensation, it can be ensured that the actuator gear position, the current position, will be essentially unaffected by the backlash. In particular, precise control may be obtained also when the total torque delivered to the actuator gear changes sign or when both motors are needed to handle large torque.

It is to be understood, that the position of the first gear, the second gear and the actuator gear are intimately connected. Thus, by for example obtaining the position of the first gear, e.g. by deducing it from the position of the first motor, the corresponding position of the actuator gear can be estimated based on the position of the first gear. Alternatively, the positions of both the first gear and the second gear may be obtained from their respective motors, and the position of the actuator gear may be estimated based on the position of the first gear and the position of the second gear. Thus, with a position of the gear train is meant the position of the first gear, the position of the second gear or the position of the actuator gear; all three positions are strongly related and are in a sense equivalent.

According to one embodiment the first backlash compensation is determined by summing the first component that is half of the current backlash value times a sign function of the motor torque of the first motor and a second component that is a first torque offset divided by the product of a positive gain proportionality constant and a speed control proportionality constant, and which first torque offset is a function of the total torque.

The total torque is the torque of the actuator gear, i.e. the resulting torque of the first gear and the second gear applied to the actuator gear.

According to one embodiment the second backlash compensation is determined by summing the third component that is half of the current backlash value times a sign function of the motor torque of the second motor and a fourth component that is a second torque offset divided by the product of a positive gain proportionality constant and a speed control proportionality constant, and which second torque offset is a function of the total torque. The current position of the actuator gear will therefore during the entire control operation be in the middle of the backlash, giving excellent path performance.

One embodiment comprises e) reducing an motor torque to that motor of the first motor and the second motor that provides a braking action on the actuator gear to actuate the actuator gear in a desired drive direction.

Thus, in case the actuator gear torque is increased to a level where both the first motor and the second motor needs to be utilized to drive the actuator gear, the fixation of the actuator gear provided by the first motor and the second motor due to opposite torques resulting from the first backlash compensation and the second backlash compensation, is gradually released. The braking effect of the braking motor is thus decreased and eventually this motor will also become driving so that both the first motor and the second motor drive the actuator gear in parallel.

One embodiment comprises, prior to step a): i) bringing the first gear into a first position in which a first gear flank of the first gear is in contact with a first actuator gear flank by driving the first motor in a first direction and simultaneously bringing the second gear into a second position in which a first gear flank of the second gear is in contact with a second actuator gear flank of the actuator gear by driving the second motor in a second direction opposite to the first direction, and ii) determining the first position of the first gear relative to a first reference position of the first motor and determining the second position of the second gear relative to a second reference position of the second motor.

One embodiment comprises: iii) bringing the first gear into a third position in which a second gear flank of the first gear is in contact with a third actuator gear flank by driving the first motor in the second direction and simultaneously bringing the second gear into a fourth position in which a second gear flank of the second gear is in contact with a fourth actuator gear flank by driving the second motor in the first direction, and iv) determining the third position of the first gear relative to the reference position and determining the fourth position of the second gear relative to the reference position.

One embodiment comprises: v) determining a first difference value by subtracting the fourth position from the third position, determining a second difference value by subtracting the third position from the first position, and vi) determining a backlash for the present position by determining a difference between the first difference value and the second difference value and dividing the difference by two.

One embodiment comprises vii) based on at least one of the first position, second position, third position and fourth position obtaining a position of the gear train and storing the position and the corresponding backlash value as a pair in the data structure.

One embodiment comprises repeating steps i)-vii) for a plurality of positions along the entire working range of the actuator gear.

According to a second aspect of the present disclosure there is provided a computer program for controlling backlash by means of a first motor arranged to drive a first gear and a second motor arranged to drive a second gear, which first gear and second gear are mechanically connected in parallel with an actuator gear, and which first gear, second gear and third gear form a gear train, wherein the computer program comprises computer code which, when run on a processing unit of a controller system, causes the controller system to: a) obtain a current position of the gear train relative to a reference position of the gear train, b) obtain a current backlash value for the current position from a data structure comprising a plurality of pairs of positions of the actuator gear and corresponding backlash values which have all been determined in an empirical manner for the actuator gear, the first gear and the second gear under control, which positions contained in the data structure are distributed along the entire work range of the actuator gear, and wherein the current backlash value is obtained by finding a position of the gear train in the data structure corresponding to the current position and thereby identifying the corresponding backlash, c) determine a first backlash compensation for the first motor and a second backlash compensation for the second motor, wherein the first backlash compensation is based on a first component that includes the current backlash value with the sign of the first component being a function of a motor torque of the first motor and the second backlash compensation is based on a third component that includes the current backlash value with the sign of the third component being a function of a motor torque of the second motor, and e) control the first motor based on the first backlash compensation and controlling the second motor based on the second backlash compensation.

According to a third aspect of the present disclosure there is provided a computer program product comprising a computer program according to the second aspect, and a storage unit on which the computer program is stored.

According to a third aspect of the present disclosure there is provided a controller system configured to control backlash by means of a first motor arranged to drive a first gear and a second motor arranged to drive a second gear, which first gear and second gear are mechanically connected in parallel with an actuator gear, and which first gear, second gear and third gear form a gear train, wherein the controller system comprises: a processing unit, and a storage unit containing computer code, wherein the computer code when run on the processing unit causes the controller system to: a) obtain a current position of the gear train relative to a reference position of the gear train, b) obtain a current backlash value for the current position from a data structure comprising a plurality of pairs of positions of the gear train and corresponding backlash values which have all been determined in an empirical manner for the actuator gear, the first gear and the second gear under control, which positions contained in the data structure are distributed along the entire work range of the actuator gear, and wherein the current backlash value is obtained by finding a position of the gear train in the data structure corresponding to the current position and thereby identifying the corresponding backlash value, c) determine a first backlash compensation for the first motor and a second backlash compensation for the second motor, wherein the first backlash compensation is based on a first component that includes the current backlash value with the sign of the first component being a function of a motor torque of the first motor and the second backlash compensation is based on a third component that includes the current backlash value with the sign of the third component being a function of a motor torque of the second motor, and d) control the first motor based on the first backlash compensation and controlling the second motor based on the second backlash compensation.

According to one embodiment the first backlash compensation is determined by summing the first component that is half of the current backlash value times a sign function of the motor torque of the first motor and a second component that is a first torque offset divided by the product of a positive gain proportionality constant and a speed control proportionality constant, and which first torque offset is a function of the total torque, and the second backlash compensation is determined by summing the third component that is half of the current backlash value times a sign function of the motor torque of the second motor and a fourth component that is a second torque offset divided by the product of a positive gain proportionality constant and a speed control proportionality constant, and which second torque offset is a function of the total torque.

According to one embodiment the controller system is configured to: e) reduce an output torque to that motor of the first motor and the second motor that provides a braking action on the actuator gear to thereby actuate the actuator gear in a desired drive direction.

According to a fifth aspect of the present disclosure there is provided an industrial robot system comprising an industrial robot, an actuator gear arranged to actuate the industrial robot, a first motor and a second motor, a first gear arranged to be driven by the first motor and a second gear arranged to be driven by the second motor, wherein the first gear and the second gear are mechanically connected in parallel with the actuator gear, and a controller system according to the fourth aspect, which controller system is configured to control the first motor and the second motor.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 is a schematic block diagram of a controller system configured to control backlash by means of a first gear driven by a first motor and a second gear driven by a second motor, which first gear and second gear are mechanically connected in parallel with an actuator gear;

FIG. 2 is a control scheme for controlling backlash by means of the controller system in FIG. 1;

FIG. 3 schematically shows a first gear and a second gear engaging with an actuator gear;

FIGS. 4a-d show various positions of gear flank interaction between the gear train in FIG. 3 and in FIG. 4;

FIG. 5a is a flowchart of a method of collecting individual backlash values for use in a method of controlling backlash;

FIG. 5b is a flowchart of controlling backlash based on the collected backlash values;

FIG. 6 is a graph depicting torque offset as a function of the total torque for a first motor and a second motor in accordance with the method presented herein; and

FIG. 7 schematically shows an industrial robot system comprising the controller system in FIG. 1.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

The present disclosure relates to a method of controlling backlash by means of a first motor driving a first gear and a second motor driving a second gear. The first gear and the second gear are mechanically connected in parallel with an actuator gear. The first gear, the second gear and the actuator gear thereby form a gear train. The actuator gear is arranged to actuate an object such as an industrial robot or an arrangement that includes an industrial robot. The actuator gear may be a cog wheel or a rack.

The method includes two aspects. A first aspect of the method is to create a pairing between the position of the gear train relative to a reference position of the gear train and a backlash value that is determined for that position. Such pairings are made for a plurality of positions of the gear train along the entire working range of the actuator gear. The pairings are stored in a data structure, for example as a matrix forming a look-up table. The backlash for each position is determined by simultaneously applying oppositely directed torques to the first gear and to the second gear by means of respective motors, so that both gears have a respective gear flank pressing against a respective gear flank of the actuator gear and then moving the respective cog of the first gear and the second gear to the closest adjacent cog of the actuator gear and applying torques in the opposite direction. Based on position measurements of the first gear and the second gear relative to the reference position of the gear train, the backlash may be determined. By determining the backlash for a plurality of positions along the entire working range of the actuator gear, the backlash for the actuator gear, the first gear and the second gear used in the particular control scheme may be determined. The backlash values for a plurality of positions are hence determined empirically for a specific gear train, i.e. an arrangement comprising the actuator gear, the first gear and the second gear.

In a second aspect of the method, the information collected according to the first aspect, i.e. the pairs of positions and backlash values stored in the data structure, is used for controlling the gear train and to reduce the backlash. For any position of the gear train, and thus of the actuator gear, the backlash compensation for each motor is based on the backlash value corresponding to the current position, obtained from the data structure. The controller is hence configured to provide opposite directional torque to the first gear and to the second gear, respectively, to reduce the backlash. This opposite directional torque may have the same magnitude e.g. in case stationary positioning is desired, or the magnitude of the opposite directional torques may differ. In the former case, the total torque is zero and thus a stationary position is obtained. In the latter case, there will be a total torque that differs from zero and the actuator gear will be driven in the direction in accordance with the total torque. The controller is furthermore configured to provide torque in the same direction to both the first gear and the second gear simultaneously, to obtain parallel drive operation of the actuator gear, if necessary, for example when a larger total torque is required. In this manner there is provided a fixation or spanning of the actuator gear by means of the first motor and the second motor, during operation when the torques have opposite direction to reduce backlash or a parallel drive operation in which the first gear and the second gear both contribute to driving the actuator gear in a desired direction. Hence, during actuator gear control the controller is configured to provide a continual pattern of opposite directional torques to the first gear and the second gear, respectively, with varying magnitude and to provide torques with the same direction, with varying magnitude to both the first gear and the second gear simultaneously to drive the actuator gear with both the first gear and the second gear simultaneously in case a larger total torque is desired.

The methods and controller systems presented herein may be utilised with two or more motors and a corresponding number of gears driven by a respective motor.

The method will now be described in more detail with reference to the drawings.

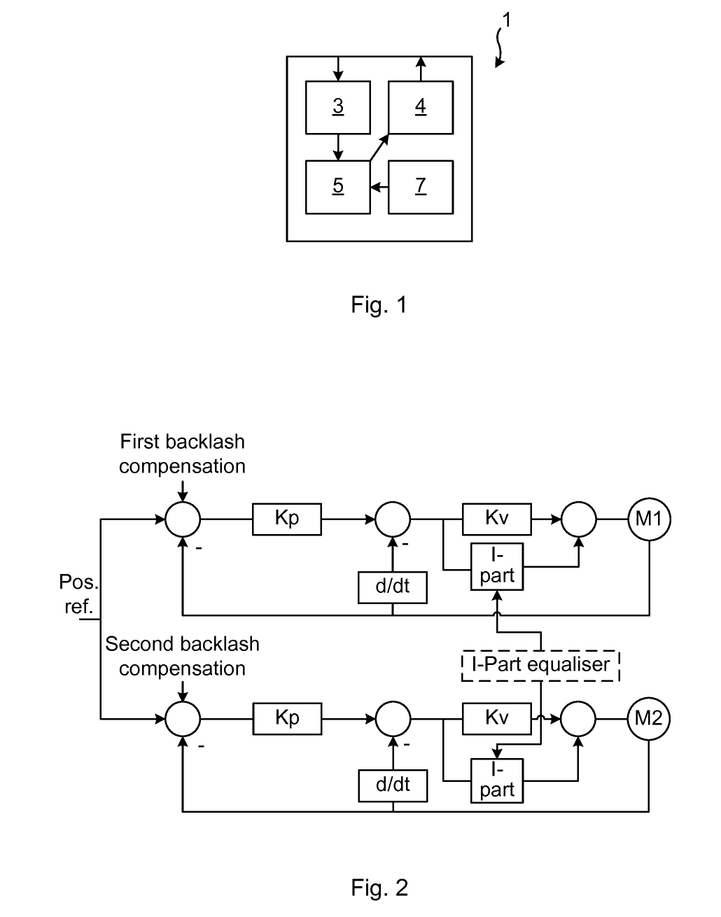

FIG. 1 shows a block diagram of a controller system 1 configured to control backlash by means of a first motor arranged to drive a first gear and a second motor arranged to drive a second gear. For this purpose, the first gear and second gear are mechanically connected in parallel with an actuator gear. The controller system 1 comprises an input unit 3 configured to receive the positions of the first motor and the second motor to thereby obtain measures of the positions of the first gear and the second gear, and of the actuator gear, and thus of the current position of the gear train, a storage unit 7 comprising computer code, a processing unit 5 and an output unit 4, which is configured to communicate with the processing unit 5 and to output control signals to an electrical drive for controlling a motor. The controller system 1 is configured to control the first motor and the second motor according to the methods that will be described in more detail in the following when the computer code stored in the storage unit 7 is run on the processing unit 5.

FIG. 2 shows an example of a control scheme for the controller system 1. The controller system 1 may comprise a respective controller for each motor, according to the example a first motor M1 and a second motor M2. In this case, the processing unit of the controller system 1 may comprise several distinct processors, e.g. one for each controller.

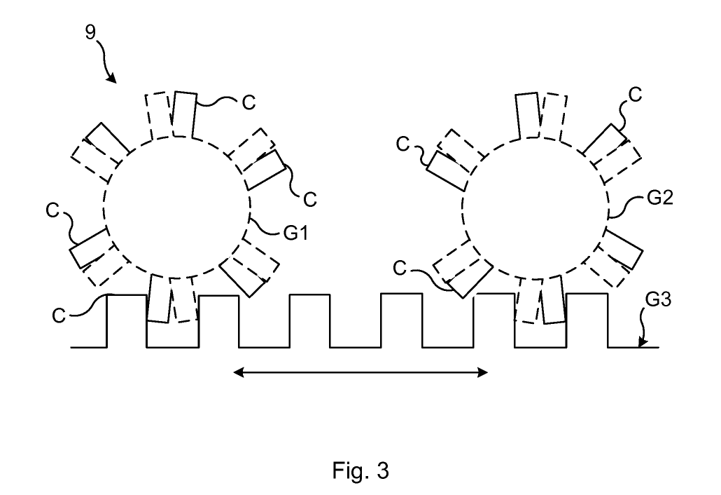

FIG. 3 shows a gear train 9 including a first gear G1 arranged to be driven by a first motor M1 and a second gear arranged to be driven by a second motor M2. The first gear G1 and the second gear G2 in turn are arranged to drive or actuate an actuator gear G3. Each one of the first gear G1, the second gear G2 and the actuator gear G3 thus comprises a plurality of cogs C so that rotation of the first gear G1 and the second gear G2 leads to actuation of the actuation gear G3. Both the first gear G1 and the second gear G2 are shown in two different positions. The positions shown with the solid lines of the cogs describe a first simultaneous position of the first gear G1 and the second gear G2 and the dashed lines of the cogs describe a second simultaneous position of the first gear G1 and the second gear G2. These positions of the first gear G1 and the second gear G2 are used to determine the backlash, i.e. backlash value, for a specific position of the actuator gear G3, as will be described in more detail below.

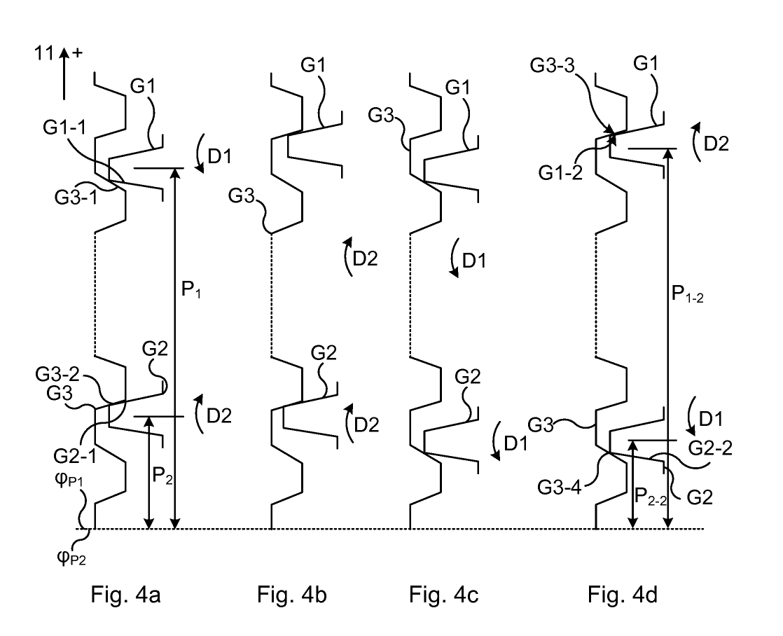

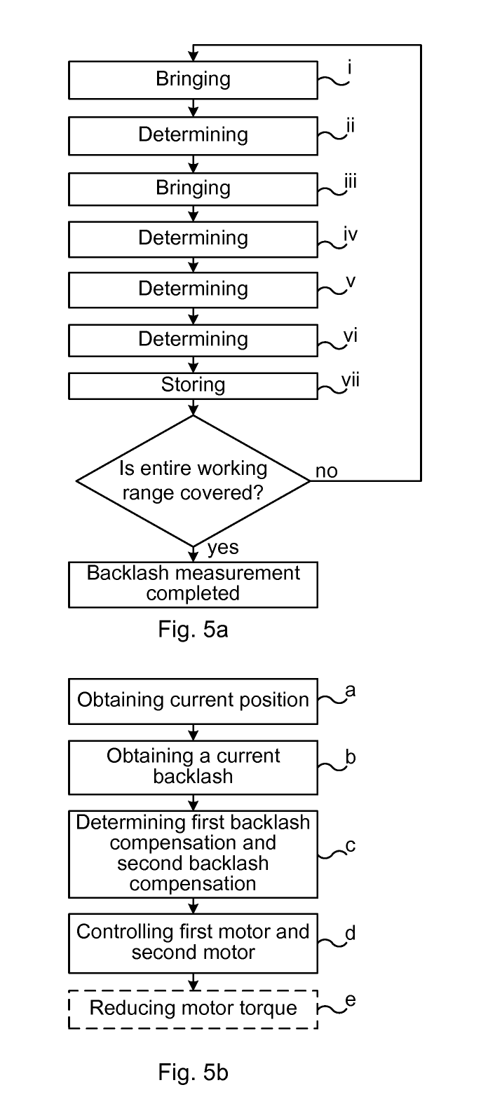

FIGS. 4a and 4d, and FIG. 5a show the process by which the backlash value is determined for a specific position of the gear train 9, and thus of the actuator gear G3. This process is repeated for a plurality of positions of the gear train 9 along the entire working range of the actuator gear G3 during commissioning. A reference direction is shown by means of the arrow 11 and the plus sign.

In a step i) the first gear G1 is brought into a first position p1 in which a first gear flank G1-1 of the first gear G1 is brought into contact with a first actuator gear flank G3-1 of the actuator gear G3 by driving the first motor M1 in a first direction D1. Simultaneously the second gear G2 is brought into a second position p2 a first gear flank G2-1 of the second gear G2 is brought into contact with a second actuator gear flank G3-2 of the actuator gear G3 by driving the second motor M2 in a second direction D2 opposite to the first direction D1. The first actuator gear flank G3-1 and the second actuator gear flank G3-2 are flanks of different cogs, i.e. there is hence one or more cogs of the actuator gear G3 between the first actuator gear flank G3-1 and the second actuator gear flank G3-2. According to one variation, in step i) the first gear G1 and the second gear G2 are rotated towards each other when driven in the first direction D1 and the second direction D2, respectively. The first gear and the second gear could however alternatively be driven in directions away from each other in step i).

In a step ii) the first position p1 of the first gear G1 relative to a first reference position φₚ₁ of the first motor M1 is determined by the processing unit 5. The first reference position φₚ₁ of the first motor M1 is of course equivalent to being a first reference position of the first gear G1 and conversely the first position of the first gear G1 may be seen as a first position of the first motor M1. In particular, information about each of these positions is provided by the first motor M1 to the controller system 1. Moreover, the second position p2 relative to a second reference position φₚ₂ is determined by the processing unit. In the same manner as described above, the second reference position φₚ₂ of the second motor M2 is equivalent to being a second reference position of the second gear G2 and conversely the second position of the first gear G1 may be seen as a second position of the second motor M2. This is schematically illustrated in FIG. 4a. It should be noted that for simplicity the first reference position and the second reference position are the same in the example in FIGS. 4a-d, but they could however also differ.

In a step iii) the first gear G1 is brought into a third position p1-2 in which a second gear flank G1-2 of the first gear G1 is brought into contact with a third actuator gear flank G3-3 by driving the first motor M1 in the second direction D2. The second gear flank G1-2 of the first gear G1 is on the same cog as the first gear flank G1-1 of the first gear G1. Simultaneously the second gear G2 is brought into a fourth position p2-2 in which a second gear flank G2-2 of the second gear G2 is brought into contact with a fourth actuator gear flank G3-4 by driving the second motor M2 in the first direction D1. The second gear flank G2-2 of the second gear G2 is on the same cog as the first gear flank G2-1 of the second gear G2. In this case, the first gear G1 and the second gear G2 are rotated away from each other. The third actuator gear flank G3-3 is the flank of the opposite cog relative to the first actuator gear flank G3-1, in the same cog gap. The fourth actuator gear flank G3-4 is the flank of the opposite cog relative to the second actuator fear flank G3-2, in the same cog gap. The cog of the first gear G1 has hence only been moved in the gap between two facing surfaces of the two adjacent cogs of the actuator gear. Similarly, the cog of the second gear G2 has hence only been moved in the gap between two facing surfaces of the two adjacent cogs of the actuator gear. This is illustrated in FIG. 5d.

In a step iv) the third position p1-2 relative to the first reference position φₚ₁ is determined by the processing unit 5. Moreover a fourth position p2-2 relative to the second reference position φₚ₂ is determined by the processing unit 5.

In a step v) a first difference value is determined by subtracting the fourth position p2-2 from the third position p1-1. Moreover a second difference value is determined by subtracting the second position p2 from the first position p1.

In a step vi) a backlash for the present position φₚ is determined by determining a difference between the first difference value and the second difference value and dividing the difference by two. The backlash value, BV, is hence determined by equation (1) below. It should be mentioned that normally, steps v) and vii) may be carried out in a single step.

$$BV = \frac{( {p}_{1 - 2} - {p}_{2 - 2} ) - ( {p}_{1} - {p}_{2} )}{2} = \frac{{p}_{1 - 2} - {p}_{1} - {p}_{2 - 2} + {p}_{2}}{2} \qquad ( 1 )$$

In a step vii) based on at least one of the first position, second position, third position and fourth position a position of the gear train is obtained and this position and the corresponding backlash value are stored as a pair in the data structure in the storage unit 7. Steps i)-vii) are repeated for a plurality of positions distributed along the entire working range of the actuator gear G3. Steps i) to vii) are typically performed during commissioning such that backlash for the gear train that is to be controlled can be determined for a plurality of positions of the gear train 9. These steps are hence normally not performed once commissioning has ended, i.e. during regular motor control.

It should be noted that in the event that the actuator gear G3 is a rack, the four positions, i.e. the first position, the second position, the third position and the fourth position are processed as distances relative to the corresponding reference positions, and the backlash values are advantageously stored as distances. In case the actuator gear G3 is a cog wheel, the four positions mentioned above are processed as angles, and the backlash values are stored as angles. These positions may in both cases be determined e.g. by means of measuring the number of rotations of the rotor of each motor relative to a reference position of the respective rotor and which can then be translated into angles or distances.

FIGS. 5b-c show positions of the first gear G1 and the second gear G2, when both the first gear G1 and the second gear G2 drive the actuator gear G3 simultaneously and thus provide torque in the same direction. These are typical situations when a larger torque is required, for example for accelerating the actuator gear G3. Both the first gear G1 and the second gear G2 may therefore be rotated in the first direction D1 or in the second direction simultaneously. It may additionally be noted that the positions of the first gear G1 and the second gear G2 shown in FIGS. 5a and 5d may also provide actuation of the actuator gear G3. These positions reduce backlash but may also drive the actuator gear G3 if the total torque differs from zero. One of the first gear G1 and the second gear G2 may thus for example have a greater torque magnitude than the other, resulting in a total torque that differs from zero. The actuator gear G3 is thereby actuated in the direction of the total torque while backlash is reduced.

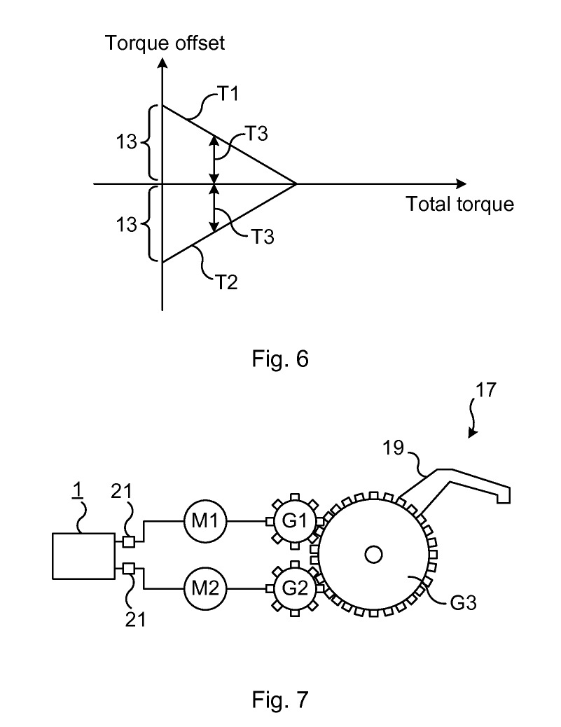

Referring to FIG. 6b, a method of controlling backlash by means of the first gear G1 and the second gear G2 will now be described.

In a step a) a current position of the gear train 9 relative to a reference position of the gear train is obtained. As previously noted, this current position may be the position of the first motor M1, i.e. the current position of the first gear G1, or the current position of the second motor M2, i.e. the current position of the second gear G2, or the current position of the actuator gear G3, which may be estimated based on the current position of the first gear G1 and the current position of the second gear G2, for example as the average of these current positions.

| | φ (position, in degrees) | | | | | | | | |
|---|---|---|---|---|---|---|---|---|---|
| | 0 | 20 | 40 | 60 | 80 | 100 | 120 | 140 | 160 |
| Backlash | B1 | B2 | B3 | B4 | B5 | B6 | B7 | B8 | B9 |

In a step c) a first backlash compensation for the first motor is determined and a second backlash compensation for the second motor is determined. The first backlash compensation is based on a first component that includes the current backlash value. The sign of the first component is a function of a motor torque of the first motor. The second backlash compensation is based on a third component that includes the current backlash value. The sign of the third component is a function of a motor torque of the second motor.

According to one variation the first backlash compensation is determined by summing the first component that is half of the current backlash value multiplied with the sign function of the motor torque of the first motor and a second component that is a first torque offset divided by the product of a positive gain proportionality constant Kp and a speed control proportionality constant Kv. The first torque offset is a function of the total torque. The first torque offset is the torque offset of the first motor M1. The second component is equal to torque_offset_m1 (total torque)/ (Kp*Kv), where Kp has unit 1/s and Kv has unit Nm*s/degree in case the actuator gear G3 is a cog wheel and Nm*s/m in case the actuator gear G3 is a rack. The unit of the first backlash compensation is hence degrees or meters depending on whether the actuator gear operates with rotational motion or linear motion. The second backlash compensation is determined by summing a third component that is half of the current backlash value multiplied with the sign function of the motor torque of the second motor and a fourth component that is a second torque offset divided by the product of the positive gain proportionality constant Kp and the speed control proportionality constant Kv. The second torque offset is a function of the total torque. The second torque offset is the torque offset of the second motor M2. Here, the denominator is the same as for the second component. The unit of the second backlash compensation is the same as for the first backlash compensation. The backlash compensations may hence be expressed as follows.

$$\begin{matrix}First backlash compensation = \frac{Backlash ( current position )}{2} . \\ sign ( {torque}_{M 1} ) + \frac{Torque\_offset \_m 1 ( Total\_torque )}{Kp \cdot Kv} & ( 2 ) \\ Second backlash compensation = \frac{Backlash ( current position )}{2} . \\ sign ( {torque}_{M 2} ) + \frac{Torque\_offset \_m2 ( Total\_torque )}{Kp \cdot Kv} & ( 3 )\end{matrix}$$

When opposite torque is desired, i.e. when reducing backlash, this means that the first component and the third component will have opposite signs since the motor torques have opposite directions. The torque offsets also have opposite signs when opposite torques are applied by the first gear G1 and the second gear G2 to the actuator gear G3. Assuming that the first torque offset and the second torque offset are linear functions mirrored in the x-axis that describes the total torque, as shown in FIG. 7, the magnitude of the first backlash compensation and the second backlash compensation is always the same, although their sign may differ.

FIG. 7 depicts a plot with the total torque applied to the actuator gear G3 on the x-axis, and the motor torque for each motor M1 and M2 on the y-axis when one of the motors provide a braking action and the other motor provides a driving action. Graph T1 shows the motor torque of the motor providing the driving action and graph T2 shows the motor torque of the motor providing the braking action. The torque offsets are denoted by T3. An initial offset 13 from zero motor torque is selected to be large enough to be able to maintain the position of the actuator gear G3 when it is subjected to certain external forces.

In a step d) the first motor M1 is controlled based on the first backlash compensation and the second motor M2 is controlled based on the second backlash compensation. In this way, the actuator gear G3 may be spanned up or fixated by the first gear G1 and the second gear G2 to reduce backlash.

In order to drive the actuator gear G3, i.e. to make it move in one direction, one of the motor torques must be greater than the other in magnitude. Hence, when the actuator gear G3 is to be driven, the method includes a step e) of reducing a motor torque of that of the first motor M1 and the second motor M2 that provides a braking action on the actuator gear G3, to actuate the actuator gear (G3) in a desired drive direction. This motor torque may for example be reduced until the motor torque reaches zero and may thereafter be increased to drive the actuator gear G3 in parallel with the driving gear of the first gear G1 and the second gear G2. Step e) may hence involve gradually changing the scaled torque offset of that motor of the first motor and the second motor which contributes to the braking action such that the torque offset is reduced to zero.

Typically steps a) to e) are repeated continually when controlling the actuator gear G3. When repeated, normally only steps a) to e) are repeated without repetition of steps i) to vii).

FIG. 8 shows an example of an industrial robot system 17, which is an example of an application in which the controller system 1 may be utilised. The industrial robot system comprises the first gear G1, the first motor M2 arranged to drive the first gear G1, the second gear G2, the second motor M2 arranged to drive the second gear G2, and the actuator gear G3. The first gear G1 and the second gear G2 are arranged to be mechanically connected in parallel with the actuator gear G3 and to drive the actuator gear G3. The industrial robot system 17 further comprises an industrial robot 19, the controller system 1 and electrical drives 21. The controller system 1 is arranged to control the first motor M1 and the second motor M2 by means of the electrical drives 21 to thereby drive the first gear G1 and the second gear G2, respectively. The actuator gear G3 is arranged to actuate the industrial robot 19. By means of the methods presented herein, the backlash in the industrial robot system 17 may be drastically reduced.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of controlling backlash by means of a first motor driving a first gear and a second motor driving a second gear, which first gear and second gear are mechanically connected in parallel with an actuator gear and which first gear, second gear and actuator gear form a gear train, wherein the method comprises:
a) obtaining a current position of the gear train relative to a reference position of the gear train,
b) obtaining a current backlash value for the current position from a data structure including a plurality of pairs of positions of the gear train and corresponding backlash values which have all been determined in an empirical manner for the actuator gear, the first gear and the second gear under control, which positions contained in the data structure are distributed along the entire work range of the actuator gear, and wherein the current backlash value is obtained by finding a position of the gear train in the data structure corresponding to the current position and thereby identifying the corresponding backlash value,
c) determining a first backlash compensation for the first motor and a second backlash compensation for the second motor, wherein the first backlash compensation is based on a first component that includes the current backlash value with the sign of the first component being a function of a motor torque of the first motor and the second backlash compensation is based on a third component that includes the current backlash value with the sign of the third component being a function of a motor torque of the second motor, and
d) controlling the first motor based of the first backlash compensation and controlling the second motor based on the second backlash compensation.

2. The method according to claim 1, wherein the first backlash compensation is determined by summing the first component that is half of the current backlash value times a sign function of the motor torque of the first motor and a second component that is a first torque offset divided by the product of a positive gain proportionality constant and a speed control proportionality constant, and which first torque offset is a function of the total torque.

3. The method according to claim 2, wherein the second backlash compensation is determined by summing the third component that is half of the current backlash value times a sign function of the motor torque of the second motor and a fourth component that is a second torque offset divided by the product of a positive gain proportionality constant and a speed control proportionality constant and which second torque offset is a function of the total torque.

4. The method according to claim 3, including:
e) reducing a motor torque to that motor of the first motor and the second motor that provides a braking action on the actuator gear to actuate the actuator gear in a desired drive direction.

5. The method according to claim 1, comprising, prior to step a):
i) bringing the first gear into a first position in which a first gear flank of the first gear is in contact with a first actuator gear flank by driving the first motor in a first direction and simultaneously bringing the second gear into a second position in which a first gear flank of the second gear is in contact with a second actuator gear flank of the actuator gear by driving the second motor in a second direction opposite to the first direction, and
ii) determining the first position of the first gear relative to a first reference position of the first motor and determining the second position of the second gear relative to a second reference position of the second motor.

6. The method according to claim 5, including:
iii) bringing the first gear into a third position in which a second gear flank of the first gear is in contact with a third actuator gear flank by driving the first motor in the second direction and simultaneously bringing the second gear into a fourth position in which a second gear flank of the second gear is in contact with a fourth actuator gear flank by driving the second motor in the first direction, and
iv) determining the third position of the first gear relative to the first reference position and determining the fourth position of the second gear relative to the second reference position.

7. The method according to claim 6, including:
v) determining a first difference value by subtracting the fourth position from the third position, determining a second difference value by subtracting the second position from the first position, and
vi) determining a backlash for the present position by determining a difference between the first difference value and the second difference value and dividing the difference by two.

8. The method according to claim 7, including vii) based on at least one of the first position, second position, third position and fourth position obtaining a position of the gear train and storing the position and the corresponding backlash value as a pair in the data structure.

9. The method according to claim 8, including repeating steps i)-vii) for a plurality of positions along the entire working range of the actuator gear.

10. A computer program for controlling backlash by means of a first motor arranged to drive a first gear and a second motor arranged to drive a second gear, which first gear and second gear are mechanically connected in parallel with an actuator gear, and which first gear, second gear and actuator gear form a gear train, wherein the computer program includes computer code which, when run on a processing unit of a controller system, causes the controller system to:
a) obtain a current position of the actuator gear relative to a reference position of the gear train,
b) obtain a current backlash value for the current position from a data structure including a plurality of pairs of positions of the gear train and corresponding backlash values which have ail been determined in an empirical manner for the actuator gear, the first gear and the second gear under control, which positions contained in the data structure are distributed along the entire work range of the actuator gear, and wherein the current backlash value is obtained by finding a position of the gear train in the data structure corresponding to the current position and thereby identifying the corresponding backlash value,
c) determine a first backlash compensation for the first motor and a second backlash compensation for the second motor, wherein the first backlash compensation is based on a first component that includes the current backlash value with the sign of the first component being a function of a motor torque of the first motor and the second backlash compensation is based on a third component that includes the current backlash value with the sign of the third component being a function of a motor torque of the second motor, and
d) control the first motor based on the first backlash compensation and controlling the second motor based on the second backlash compensation.

11. A computer program product including a computer program according to claim 10, and a storage unit on which the computer program is stored.

12. A controller system configured to control backlash by means of a first motor arranged to drive a first gear and a second motor arranged to drive a second gear, which first gear and second gear are mechanically connected in parallel with an actuator gear, and which first gear, second gear and actuator gear form a gear train, wherein the controller system comprises:
a processing unit, and
a storage unit containing computer code, wherein the computer code when run on the processing unit causes the controller system to:
a) obtain a current position of the gear train relative to a reference position of the gear train,
b) obtain a current backlash value for the current position of the gear train from a data structure including a plurality of pairs of positions of the gear train and corresponding backlash values which have all been determined in an empirical manner for the actuator gear, the first gear and the second gear under control, which positions contained in the data structure are distributed along the entire work range of the actuator gear, and wherein the current backlash value is obtained by finding a position of the gear train in the data structure corresponding to the current position and thereby identifying the corresponding backlash value,
c) determine a first backlash compensation for the first motor and a second backlash compensation for the second motor, wherein the first backlash compensation is based on a first component that includes the current backlash value with the sign of the first component being a function of a motor torque of the first motor and the second backlash compensation is based on a third component that includes the current backlash value with the sign of the third component being a function of a motor torque of the second motor, and
d) control the first motor based on the first backlash compensation and controlling the second motor based on the second backlash compensation.

13. The controller system as claimed in according to claim 12, wherein the first backlash compensation is determined by summing the first component that is half of the current backlash value times a sign function of the motor torque of the first motor and a second component that is a first torque offset divided by the product of a positive gain proportionality constant and a speed control proportionality constant, and which first torque offset is a function of the total torque, and the second backlash compensation is determined by summing the third component that is half of the current backlash value times a sign function of the motor torque of the second motor and a fourth component that is a second torque offset divided by the product of a positive gain proportionality constant and a speed control proportionality constant, and which second torque offset is a function of the total torque.

14. The controller system according to claim 13, wherein the controller system is configured to:
e) reduce an output torque to that motor of the first motor and the second motor that provides a braking action on the actuator gear to thereby actuate the actuator gear in a desired drive direction.

15. An industrial robot system comprising:
an industrial robot,
an actuator gear arranged to actuate the industrial robot,
a first motor and a second motor,
a first gear arranged to be driven by the first motor and a second gear arranged to be driven by the second motor, wherein the first gear and the second gear are mechanically connected in parallel with the actuator gear, and
a controller system configured to control the first motor and the second motor having:
a processing unit, and
a storage unit containing computer code, wherein the computer code when run on the processing unit causes the controller system to:
a) obtain a current position of the gear train relative to a reference position of the gear train,
b) obtain a current backlash value for the current position of the gear train from a data structure Including a plurality of pairs of positions of the gear train and corresponding backlash values which have all been determined in an empirical manner for the actuator gear the first gear and the second gear under control, which positions contained in the data structure are distributed along the entire work range of the actuator gear, and wherein the current backlash value is obtained by finding a position of the gear train in the data structure corresponding to the current position and thereby identifying the corresponding backlash value.
c) determine a first backlash compensation for the first motor and a second backlash compensation for the second motor wherein the first backlash compensation is based on a first component that includes the current backlash value with the sign of the first component being a function of a motor torque of the first motor and the second backlash compensation Is based on a third component being a function of a motor torque of the second motor, and
d) control the first motor based on the first backlash compensation and controlling the second motor based on the second backlash compensation.
